(19) United States
(12) Patent Application Publication
(10) Pub. No.: US 2008/0004931 A1
(43) Pub. Date: Jan. 3, 2008

(54) Housewrap packaging and distribution systems and methods

(76) Inventors: Kelly Kambs, Castle Rock, CO (US); Ralph Michael Fay, Lakewood, CO (US); Marvin Lynn Mitchell, Parker, CO (US)

Correspondence Address: JOHNS MANVILLE, 10100 WEST UTE AVENUE, LITTLETON, CO, 80127, US

(21) Appl. No.: 11/477,086

(22) Filed: Jun. 28, 2006

(51) Int. Cl. G06F 9/46

(52) U.S. Cl. 705/8

(57) ABSTRACT

Systems and methods are provided for determining a housewrap package configuration, and for delivering a housewrap package to a recipient via a logistics provider. Housewrap packages can be optimized according to delivery instructions, logistics provider pricing schedules and shipping container options, and building plan drawings or specifications.

### BACKGROUND OF THE INVENTION

Embodiments of the present invention relate generally to the production of home construction products, and in particular to the packaging and distribution of housewrap material.

Builders and contractors are constantly seeking ways to build better homes and improve the overall building envelope. They continue to benefit from building products that provide superior performance and value, while also offering more efficient installation and greater energy efficiency performance.

In typical home manufacture, sheets of plastic or other material are used as housewrap to provide a weather resistive barrier to retard infusion of air, vapor, and water into to the principal structure of the house. Housewrap typically covers all of the exterior walls and extends from the roofline to the foundation. For example, after the frame and roof are constructed and covered with sheathing, a builder may install housewrap around the outside of the house to provide a continuous weather protective enclosure. The decreased air infiltration can result in increased energy efficiency and moisture control. Housewrap installation is typically carried out at the “dry-in” stage, and can help prevent or minimize the potential for mold in the exterior walls. These exterior walls are eventually covered with cladding.

Current techniques for packaging and distributing housewrap material are often hampered in many aspects. Housewrap is commonly purchased in a large package, such as a 9 foot long cardboard tube core wrapped by a 150′ length of housewrap. The result is a core that contains about 15 to 20 pounds of housewrap. Home Depot®, Lowes®, and other home building materials supply stores frequently provide housewrap in 9′×150′ sheets. In some cases, similarly wrapped 9′×100′ or 3′×100′ sheets are available. There is incentive for manufacturers to include more square footage of housewrap per cardboard tube core, so as to reduce the cost of the core per amount of housewrap sold.

Such packages can be awkward to handle, thus making installation difficult. Ladders, scaffolding, and multiple installation personnel are often required, resulting in a complicated installation process, particularly for multi-level homes, where two or more horizontal courses of sheets may be applied to a house wall and shingled or layered over one another to channel rain and moisture away from the wood frame. Moreover, these packages can be difficult to store and transport, are often ill suited for retail display and sale, and can take up odd floor space at distribution centers. For example, large rolls of housewrap are often stored on retail aisle “end caps”, resembling an oversized umbrella stand. Further, because such packages can be difficult to store in a secure location, many small or medium contractors do not wish to inventory the packages due to the risk of theft or loss.

It is estimated that 20 MM square yards of housewrap will be sold in 2006, and twice that amount will be sold in 2007. Housewrap is typically sold through a multi-step distribution process. A manufacturer produces, packages, and stores product in their warehouse. An intermediate printing process may be included, which is often performed at a separate location. The manufacturer sells product to a regional distribution center. Some regional distribution centers maintain master distribution sites throughout the U.S. Manufacturer or regional distribution centers may include means for cutting master housewrap rolls into pieces of various sizes (e.g. 100′ lengths). Regional distribution ccenters then sell product to local distributors, including lumber yards and big box building supply stores such as Home Depot®, Lowes®, Menards®, and the like. A housewrap buyer, such as an installation contractor, purchases the housewrap at the local lumber yard or big box store and then transports it to the job site. This multi-step distribution process can contribute unnecessarily to the price of the product, as all parties involved add their markup. This cost is passed on to the end buyer or eventual consumer, which is typically the homeowner. Moreover, due to their unwieldy size, packages such as 9′ or wider ×150′ sheets of housewrap on a cardboard tube do not fit well with most distribution center strategies, and shipping such packages can be expensive and inefficient.

For at least these reasons, there remains a need for improved housewrap packaging and distribution approaches that are less costly and easier to manage, and that are more user friendly for manufactures, distributors, commercial vendors, contractors, installers, and homeowners.

### BRIEF SUMMARY OF THE INVENTION

Embodiments of the present invention address these and other unfulfilled needs by providing systems, devices, and methods for providing a housewrap package to a recipient via a logistics provider. Advantageously, these approaches are well suited for allowing a builder or contractor to order a housewrap package that is customized for a particular house or building. For example, the package can contain just enough housewrap to cover a desired structure, thus minimizing waste. What is more, these improved housewrap packages are easily handled and inexpensively distributed. Product can be delivered to an end user quickly, and multiple levels of distribution, handling, and costs can be eliminated. The embodiments described herein can be implemented via optimization algorithms for an efficient and cost-effective solution to an otherwise cumbersome process.

In one aspect, the present invention provides a method of providing a housewrap package to a recipient via a logistics provider. The method can include receiving a housewrap order at a host computer, and transmitting the set of housewrap specifications from the host computer to a packaging computer of a packaging site. The housewrap order can include a set of housewrap specifications and a set of delivery instructions. The method can also include processing a sheet of housewrap at the packaging site according to the set of housewrap specifications so as to produce a housewrap package, transporting the housewrap package to the logistics provider hub, and transmitting the set of delivery instructions from the host computer to a logistics computer of a logistics provider, such that the logistics provider is instructed to deliver the housewrap package from the logistics provider hub to the recipient according to the set of delivery instructions. In some aspects, the packaging site and the logistics provider are different business entities. The set of housewrap specifications can be customized for a specific building. In some cases, the housewrap order is received at the host computer via an internet or telephonic interface. The housewrap package can be configured according to an optimization algorithm based on the housewrap order and a logistics provider pricing schedule. The logistics provider pricing schedule can include a set of preselected package sizes. In some aspects, processing the sheet of housewrap can include unwrapping a portion of the sheet of housewrap from a roll, cutting a length of the unwrapped portion of the sheet of housewrap from the roll, and packaging the length of housewrap in a container having a preselected package size according to a logistics provider pricing schedule. The recipient may include a contractor, a homeowner, and a building supply store. In some cases, the set of housewrap specifications are selected by the recipient. The set of housewrap specifications can include a length selection, a width selection, and a printing selection. In some cases, the set of delivery instructions include a shippable container size selected by the recipient. The packaging site may be located near a logistics provider hub. The method may also include adding a housewrap accessory in the housewrap package.

In another aspect, embodiments of the present invention provide methods of determining a housewrap package configuration. An exemplary method includes receiving a housewrap order, and determining the housewrap package configuration based on the housewrap order and a logistics provider pricing schedule. The housewrap order can include a set of housewrap specifications and a set of delivery instructions. The set of housewrap specifications can include a length selection and a width selection and the set of delivery instructions can include a shippable container size. In some cases, the housewrap package configuration is determined according to an optimization algorithm. In some cases, the logistics provider pricing schedule includes a set of preselected package sizes.

In yet another aspect, one embodiment of the present invention provides a system for determining housewrap package configuration. The system includes an input for receiving a housewrap order, an input for receiving a logistics provider pricing schedule, a processor coupled with each of the inputs, and a memory coupled with the processor. The memory can be configured to store a plurality of code modules for execution by the processor. The plurality of code modules can include a module for determining the housewrap package configuration based on the housewrap order and the logistics provider pricing schedule. In some aspects, the module for determining the housewrap package configuration includes an optimization algorithm. The module can be adapted to determine the housewrap package configuration based on a space use variable associated with a transport vehicle, a retail outlet, or a lumber yard.

In still another aspect, embodiments include systems for providing a housewrap package to a recipient. A system can include a host computer having a first input that receives a housewrap order, a second input that receives a logistics provider pricing schedule, and a module that determines a housewrap package configuration and a delivery plan based on the housewrap order and the logistics provider pricing schedule. A system can also include a packaging site facility having a packaging computer that receives the housewrap package configuration from the host computer, where the packaging site facility is adapted to produce the housewrap package. The system can also include a logistics provider facility having a logistics computer that receives the delivery plan from the host computer. The logistics provider facility can be adapted to deliver the housewrap package to the recipient according to the delivery plan. In some cases, the module for determining the housewrap package configuration and the delivery plan can include an optimization algorithm. The packaging site facility may be adapted to include a housewrap accessory in the housewrap package.

For a fuller understanding of the nature and advantages of the present invention, reference should be had to the ensuing detailed description taken in conjunction with the accompanying drawings.

### BRIEF DESCRIPTION OF THE DRAWINGS

FIG. 1 illustrates a method of providing a housewrap package to a recipient according to embodiments of the present invention.

FIG. 2 illustrates a method of receiving a housewrap order according to embodiments of the present invention.

FIG. 3 shows a packaging process according to embodiments of the present invention.

FIG. 4 depicts a packaging system according to embodiments of the present invention.

FIG. 5 shows a packaging procedure for a sheet of housewrap according to embodiments of the present invention.

FIGS. 6A and 6B show methods of configuring a housewrap package based on a housewrap order according to embodiments of the present invention.

FIG. 7 illustrates a housewrap package determination system according to embodiments of the present invention.

FIG. 8 depicts a system for providing a housewrap package to a recipient according to embodiments of the present invention.

### DETAILED DESCRIPTION OF THE INVENTION

Embodiments of the present invention include improved housewrap packaging approaches. By providing optimized shippable container configurations, it is possible to quickly and inexpensively provide housewrap product to a contractor, installer, retailer, homeowner, or any desired recipient. Shippable container configurations can be selected so as to maximize cost and efficiency with outsourced logistics providers such as UPS® or DHL®. Relatedly, embodiments of the present invention also include improved housewrap distribution approaches. A host computer can receive a housewrap order via the phone or internet. The host computer can then transmit the order to a packaging site and to a logistics provider to package a customized housewrap package and deliver it to a specific location. In some cases, the distribution chain will not include certain touch points such as local or regional distributors. These new techniques for selling, packaging, and distributing housewrap can optimize distribution costs, and in some embodiments provide for a 24 hour delivery format.

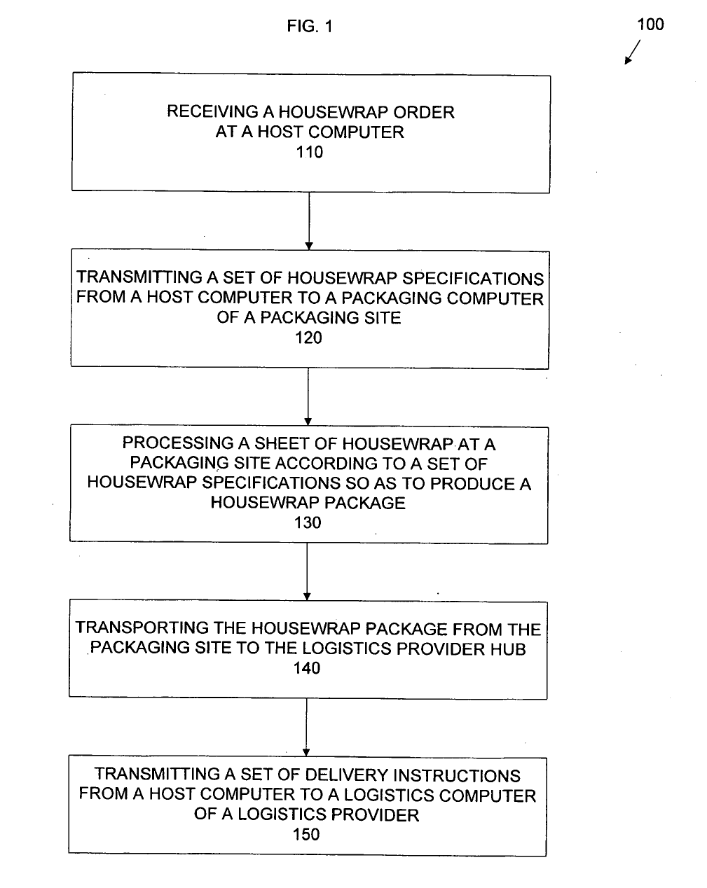

Turning now to the drawings, FIG. 1 illustrates a method 100 of providing a housewrap package to a recipient according to one embodiment of the present invention. Step 110 includes receiving a housewrap order at a host computer. Typically, the order includes a set of housewrap specifications and a set of delivery instructions. In some cases, the order may include, or be based on or calculated from, a building plan drawing or specification. Orders may be received by telephone, facsimile, a web interface, email, and the like. Orders may be received or processed by the housewrap manufacturer, or by any of a variety of associated logistics, fulfillment, and customer care providers or centers. Such providers may handle or coordinate custom call management, order placement, packaging, shipments, and fund collections. Orders may be placed by retail stores, contractors, installers, homeowners, and other individuals or entities. Step 120 includes transmitting the set of housewrap specifications from the host computer to a packaging computer of a packaging site. Such transmission may be, for example, via a printed, telephonic, or verbal interface, or the like. In many cases, the packaging site is located near a logistics provider hub. The packaging site and the logistics provider hub can both be in the same city, for example Memphis, Tenn. The logistics provider can be any of a variety of delivery or transportation services, such as UPS®, DHL®, FedEx®, and the like.

In some cases, a master roll of containing a bulk 9′×15,000 sheet of housewrap is shipped from a production site of a housewrap manufacturer to a packaging site warehouse. The packaging site may inventory any number of master rolls. In some cases, the number of rolls inventoried will be selected so as to maximize packaging efficiency. As seen in step 130, the method can include processing a sheet of housewrap at the packaging site according to the set of housewrap specifications so as to produce a housewrap package. For example, a master roll, which may or may not include generic printing, can be processed at the packaging site according to the set of housewrap specifications. In some embodiments, the packaging site includes a converting area where custom length sheets are unrolled and cut from the master roll. The custom length sheets may be wrapped around tube cores, rolled into cylinders without a core, folded into desired shapes and sizes, and the like. A housewrap package may include one or more shippable containers filled with any suitable combination of custom length sheets. Shippable containers can include boxes, sleeves, and the like. In some cases, the housewrap package includes a plurality of 2′×4′ boxes, which can be conveniently placed on a 4′×4′ pallet. Any of a variety of package delivery services or modalities may be used to transport a housewrap package from a packaging site to a logistics hub, as depicted in step 140.

Step 150 includes transmitting the set of delivery instructions from the host computer to a logistics computer of a logistics provider, such that the logistics provider is instructed to deliver the housewrap package from the logistics provider hub to the recipient according to the set of delivery instructions. For example, the logistics provider may be instructed to deliver a box, pallet, or other housewrap package shipment to a contractor, a homeowner, a home improvement product retailer, a job site, and the like. In some cases, part of the housewrap specification may be transmitted to the logistics computer, and/or part of the delivery instructions may be transmitted to the packaging computer. Optimization algorithms may be included or implemented by host computer, packaging computer, and/or logistics computer to achieve, for example, economical or efficient packaging and shipping configurations based on the housewrap order. Communication between host computer, packaging computer, and logistics computer can be effected via any of a variety of combinations of electronic, written, verbal, or human-mediated means.

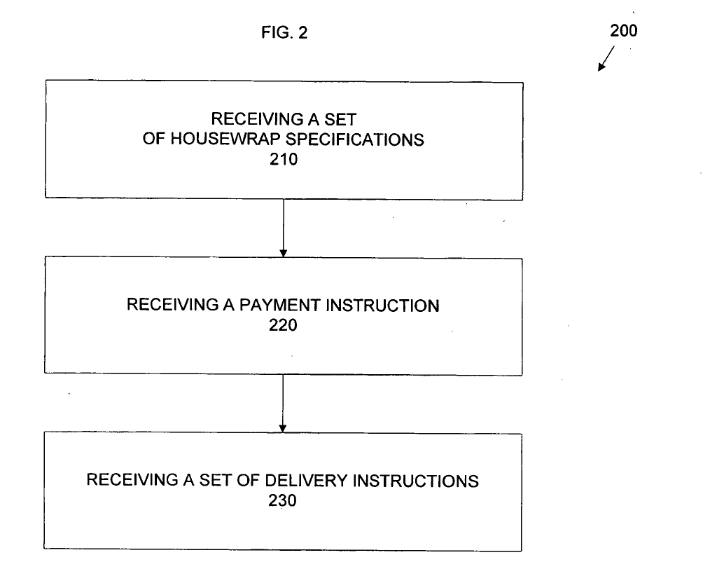

FIG. 2 illustrates a method 200 of receiving a housewrap order according to one embodiment of the present invention. As seen in step 210, the method may include receiving a set of housewrap specifications. The order typically reflects the total square footage of housewrap desired or the dimensions of the house. For example, a single story home may require a housewrap sheet width of 12′ to cover the span from foundation to roofline, and a total housewrap sheet length of 180′ to cover a total building perimeter. Thus, the customer may select desired or preferred housewrap sheet configurations to achieve the required coverage. In this instance, the customer may select a housewrap sheet width of 12′, and a housewrap sheet length of 200′. The customer may also select a logo to be printed on the housewrap. For example, the customer may choose the logo “Action Building Contractors” to be printed on the housewrap. In some cases, the customer will select a desired sheet length per individual container of the housewrap package. For example, the customer may select the housewrap to be packaged in 50′ sheet lengths. The set of housewrap specifications may also include desired accessories related to installation of the housewrap, such as contractor tape, flashing tape, seam sealant, plastic cap staples, sill pans, and the like. Accessories may be included in the housewrap package, or in a separate package that is shipped concurrently with or separately from the housewrap package.

Step 220 includes receiving a payment instruction. The customer may wish to pay via credit card such as Visa® or MasterCard®, debit, check, or any other acceptable payment method. The payment instruction may also include or reflect discounts for the customer. For example, a licensed building contractor or a customer associated with a particular home builder may receive a 15% discount from the standard price of the housewrap. Step 230 includes receiving a set of delivery instructions. In some cases, the customer may select desired or preferred shipping container sizes or shapes. For example, the customer may choose a preferred shipment configuration for housewrap packages that are folded, rolled, with tube cores, without tube cores, and the like.

Specifications and instructions such as sheet dimensions, printing options, accessories, and the like may be represented by or associated with an SKU or other input field as show in Table 1.

TABLE 1

| | | | | |
|---|---|---|---|---|
| Total Sheet | 100′ | 150′ | 200′ | Other |
| Length | SKU #1A | SKU #1A | SKU #1A | SKU #1A |
| Individual Sheet | 3′ | 8′ | 12′ | 20′ |
| Width | SKU #2A | SKU #2B | SKU #2C | SKU #2D |
| Length Per Box | 30′ | 40′ | 50′ | 60′ |
| | SKU #3A | SKU #3B | SKU #3C | SKU #3D |
| Logo | Lennar | Smith Custom | Other | None |
| | SKU #4A | SKU #4B | SKU #4C | |
| Accessories | Tape | Flashing | | |
| | SKU #5A | SKU #5B | | |
| Affiliation | Lennar | KB Homes | Ryland | Other |
| | SKU #6A | SKU #6A | SKU #6A | SKU #6A |
| Licensed | Yes | No | | |
| Contractor | | | | |
| Payment | Credit Card | Debit Card | Invoice | Check |
| Method | | | | |
| Ship Address | >Enter here< | | | |
| Ship Date | >Enter here< | | | |

A web-based interface for placing orders over the internet can incorporate such input fields. Web-based ordering systems may include an ordering component, a cash management component, an order fulfillment component, and the like. These and other related embodiments provide a convenient and efficient approach for ordering housewrap. These techniques are well suited for producing a custom job lot of housewrap packages, and provide branding and co-branding opportunities, advertising value, and name recognition for contractors, builders, retail establishments, and the like.

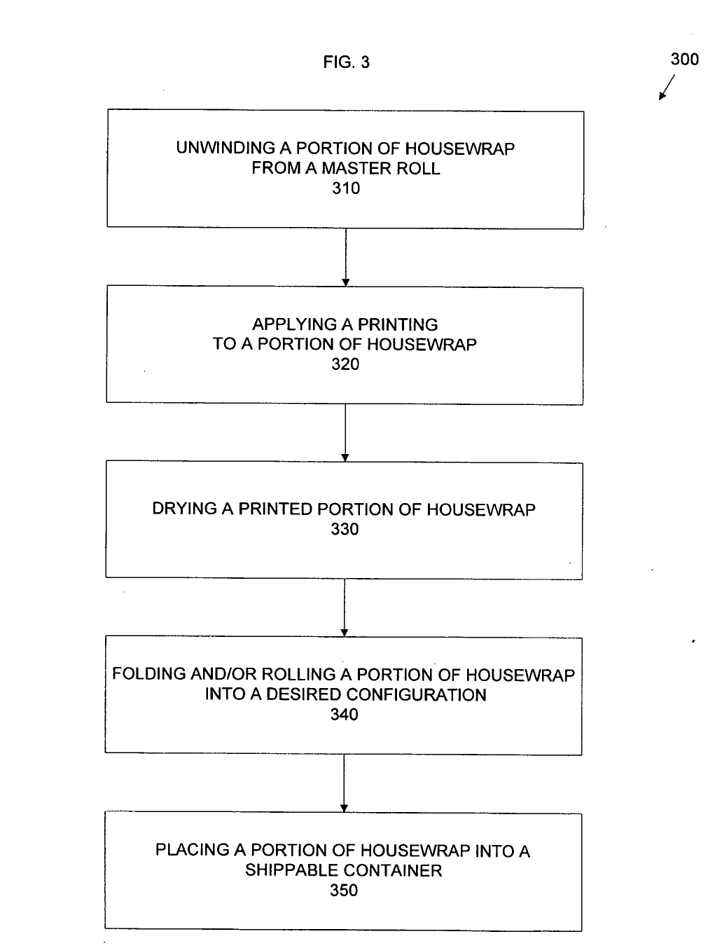

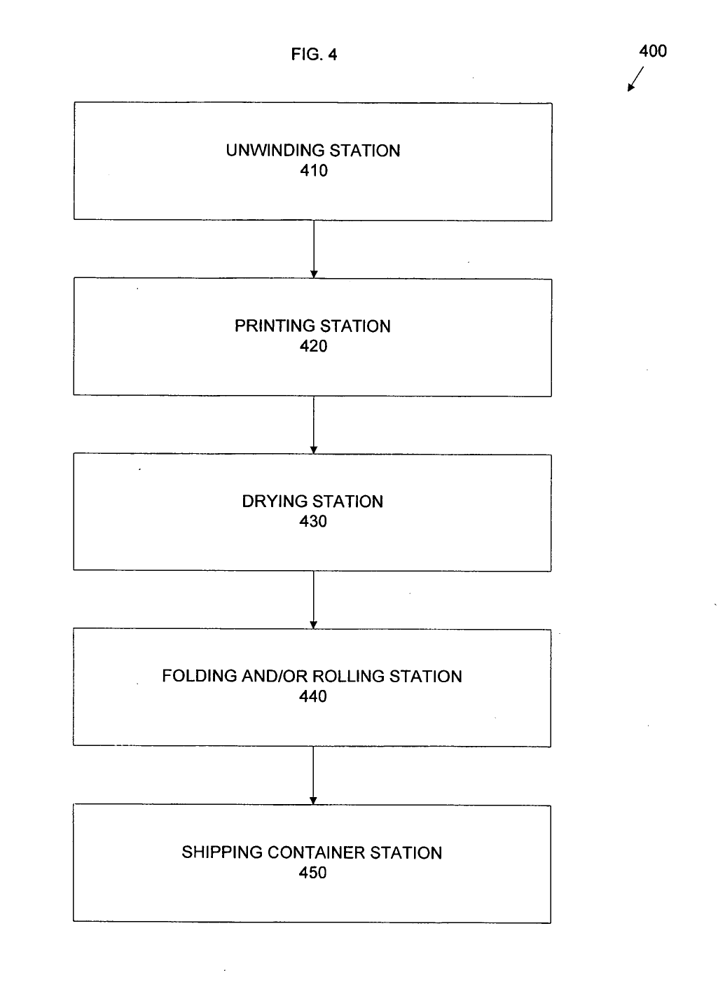

FIG. 3 illustrates a packaging process 300 according to one embodiment of the present invention. Step 310 involves unwinding a portion of housewrap from a master roll. In some cases the master roll may be pre-printed with a manufacturer label or other logo or printing. Step 320 includes printing a logo or other marking on the portion of housewrap. For example, the printing may include a builder name or home center name such as “Black's Custom Homes” or “Scatterday Lumber.” This printing may embody any of a variety of private label agreements. A drying process is shown at step 330, where the printed housewrap portion is allowed to dry. Step 340 represents a folding or rolling process, where the housewrap portion is cut from the master roll and folded and/or rolled into the desired configuration. The housewrap portion can then be placed in a box, sleeve, or other shippable container, as indicated by step 350. In some cases, accessories such as sealing tape may be included in the shippable container. Relatedly, FIG. 4 shows a packaging system 400 according to one embodiment of the present invention. Packaging system 400 includes an unwinding station 410, a printer station 420, a drying station 430, a folding and/or rolling station 440, and a shipping package station 450. In some embodiments, packaging system 400 may include a cutting station that can be placed in sequence, for example, after drying station 430 and before folding and/or rolling station 440.

Embodiments of the present invention contemplate that housewrap packages may contain housewrap sheets in any of a variety of dimensions. For example, housewrap sheets or portions thereof may have a length dimension between a range from about 20′ to about 100′. Similarly, housewrap sheets or portions thereof may have width dimensions between a range from about 3′ to about 20′. Typically, 8′, 9′, 10′, 12′ widths, and the like may be used for single story homes. Embodiments also include 18′, 20′, 24′, 28′ widths, and the like, which may be used for multi-story homes where a shingled or overlapped approach is not desired. It is also appreciated that housewrap package embodiments include shippable containers having any of a variety of dimensions. Often, a particular logistics provider can have one or more preferred, minimum, or maximum shippable package dimensions. For example, a logistics provider may offer bulk, discounted, or otherwise favorable rates for shippable packages having certain length, width, height, circumference, weight, or other dimensions or attributes. Similarly, a logistics provider may charge a premium rate for shippable packages having certain length, width, height, circumference, or other dimensions. Shippable package containers can be selected to minimize freight rates or to optimize shipping variables. In some cases, methods and system embodiments of the present invention determine and/or provide improved or optimized space utilization in a transport vehicle carrying a package, at a retail outlet, at a lumber yard, and the like.

In some cases, a customer may wish to select or customize dimensions of the housewrap sheets. Similarly, a customer may wish to select or customize dimensions of the shippable packages into which the housewrap sheets or portions thereof are packaged. For example, a home improvement retail outlet store such as Home Depots may wish to order a set of housewrap sizes having shorter lengths for easier installation (e.g. 9′×30′, 12′×30′, and 20′×30′) in housewrap packages having dimensions such that consumers visiting the store can easily handle the package, pick it up, and place it in their shopping cart. Relatedly, Home Depot® or other stores may wish to order housewrap packages that can be easily stored on their shelves. Some home improvement retailers have steel frame shelving units with certain dimensions (e.g. 8′ wide, 3′ to 8′ tall, 4′ deep). Advantageously, these retailers and other customers can select housewrap package configurations so as to optimize shelf space, thus adding another layer of efficiency and organization, and cost savings can be passed along to the consumer. The customer may also wish to configure their order so as to minimize shipping rates or to optimize any of a variety of distribution variables. In some cases, shipping package containers can be configured for use at a jobsite beyond their use as a shipping instrument. In some embodiments, a shippable container is made of corrugated plastic in a configuration that can be used as a sill pans. Shippable containers can have any of a variety of shapes, including without limitation cylindrical shapes, triangular shapes, rectangular shapes, sleeves, pouches, envelopes, and the like, or any combination thereof. Shippable containers may include flexible, semi-flexible, and rigid materials. Shippable containers may be manufactured from any of a variety of construction matter, including cardboard, paper, plastic, polymers, and the like. In some cases, a shippable container may be constructed of bubble wrap.

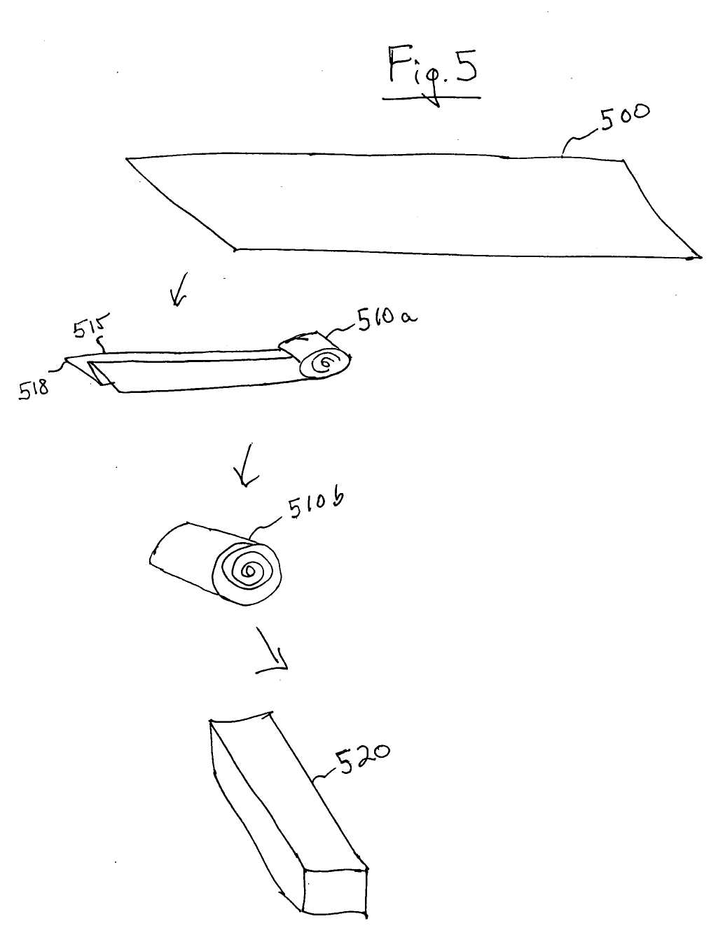

FIG. 5 illustrates a packaging procedure for a sheet of housewrap 500. Sheet 500 is folded with a “Z-fold” and then rolled as shown at 510a. The folded and rolled sheet 510b is then placed into a shippable container 520, such as an 8″×8″×48″ box. In some cases, a packaged housewrap sheet can be folded or otherwise configured to present an exposed stapling or attachment edge 515. A stapling flange can make it easy for an installer to staple the top edge of the housewrap sheet to the top side of the building to be wrapped. The sheet may also include a marked or otherwise designated starter corner 518 that identifies where to put the first staple prior to unfolding the roll. The folding pattern can permit the product to unfold below as it is unrolled. In some embodiments, a housewrap sheets may be folded into a stack instead of being wrapped on a cardboard roll, or instead of being wrapped in a cylinder without a cardboard core. The stack can then be placed in a shippable container. For example, an 8′×100′ sheet can be folded in half to a 4′×100′ dimension, and then folded in half again to a 2′×100′ dimension. The 2′×100′ folded sheet can then be folded in an accordion pattern, in 4′ lengths, to create stack. The resulting stack may weigh, for example, 14 lbs, and can be placed in a 2′×4′ package. One or more of these 2′×4′ packages can be easily placed on a 4′×4′ pallet, which can be conveniently shipped by UPS or another logistics provider. In some embodiments, the housewrap may be packaged in the shippable container along with housewrap accessories such as sealing tape.

According to another embodiment, a 9′×100′ housewrap sheet can be cut into three equal lengths of 9′×33⅓′. Each of these three portions can be folded lengthwise twice, to provide three folded sheets of 2¼′×33⅓′. The three sheets can be rolled and placed into a shippable container box along with two rolls or tape. The shippable container may have dimensions of a 8″×8″×30″ box. 40 of these boxes may be placed on a 40″×48″ pallet, and 20 loaded pallets can be placed in a freight container. The freight container may be transported from a packaging site to a customer or other destination. In this way, 800 boxes, the equivalent of 800 100′ housewrap sheets, can be conveniently and economically shipped to virtually any desired location. By comparison, in some cases the cost for shipping classic packaged rolls of 9′×100′ housewrap can be up to ten times the cost for shipping a boxed folded housewrap sheet as described above. In some embodiments, shippable containers may be covered in weather resistant wrap, stretch wrap, and the like. Such coverings can provide protection to housewrap packages when exposed to the elements, which often occurs after packages are delivered to a retailer and before the packages are moved to a protected location.

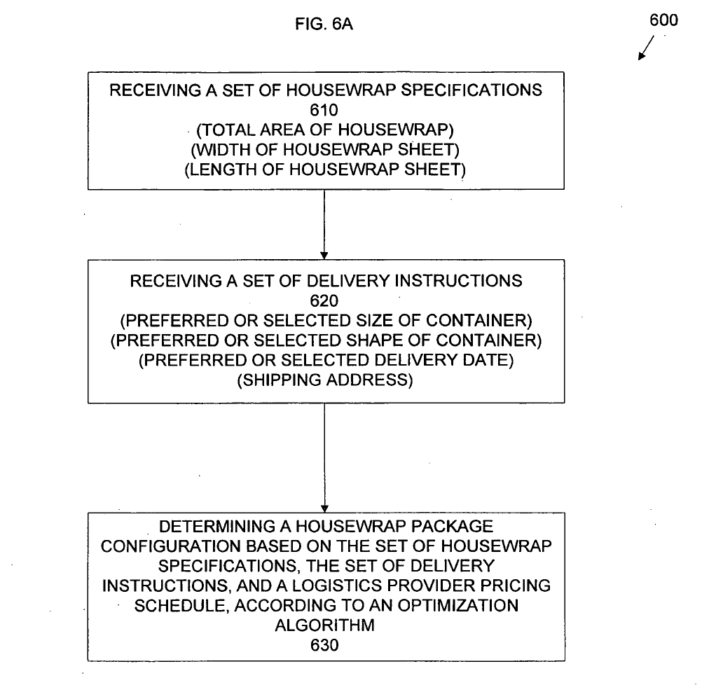

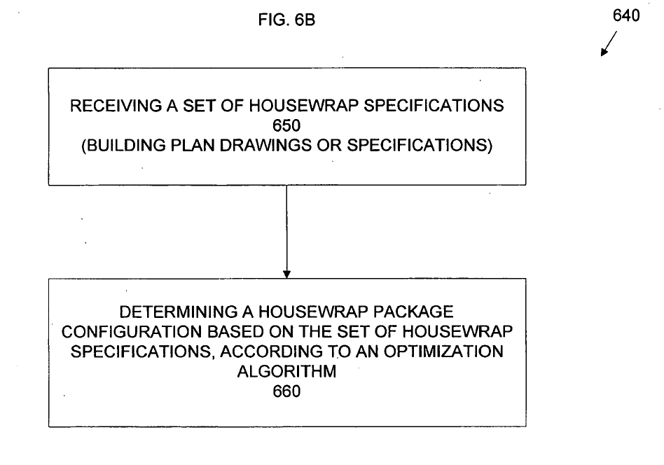

FIG. 6A illustrates a method 600 of configuring a housewrap package based on a housewrap order. Step 610 involves receiving a set of housewrap specifications. A set of housewrap specifications can include a total size, a width, and/or a length for a housewrap sheet. Step 620 involves receiving a set of delivery instructions. A set of delivery instructions can include a preferred shippable container size, a desired delivery date, and a ship address. The method also includes determining the housewrap package configuration based on the housewrap order and a logistics provider pricing schedule, as indicated in step 630. In some embodiments, the housewrap package configuration is determined according to an optimization algorithm.

For example, a customer may wish to order housewrap to cover a house having walls 10′ in height, and a perimeter of 250′, for a total area of approximately 2500 square feet. The customer may wish to receive the housewrap package, which may contain one or more individual packages, in shippable containers not exceeding a 15″ length, a 10″ height, and a 10″ width. The customer may also wish to receive the housewrap package between July 6 and July 8, to be delivered at a particular job site address. A computer or processor can determine a housewrap package configuration for the shipment, based on one or more logistics provider pricing schedules. For example, one logistics provider may not be able to deliver a housewrap package according to this particular housewrap order, whereas another logistics provider may be able to perform the delivery. In another example, a particular logistics provider may be able to perform the delivery in 12″×10″×10″ containers at a first cost, or in 15″×8″×8″ containers at a second cost, where the first cost is greater than the second cost. The computer, in implementing an optimization algorithm to minimize cost, may decide to configure the housewrap package for shipment in 15″×8″×8″ containers. In a related example, a particular logistics provider may be able to perform the delivery in 12″×10″×10″ containers on a first delivery date, or in 15″×8″×8″ containers on a second delivery date, where the customer's preferred delivery date is closer to the first delivery date than the second delivery date. The computer, in implementing an optimization algorithm to approach a desired delivery date, may decide to configure the housewrap package for shipment in 12″×10″×10″ containers. It is appreciated that optimization algorithms can be designed to consider any type of packaging or distribution variable.

FIG. 6B illustrates a method 640 of configuring a housewrap package based on a housewrap order. Step 650 involves receiving a set of housewrap specifications. A set of housewrap specifications can be based on a building plan drawing or specification. In some cases, the set of housewrap specifications includes information regarding the dimensions of various walls in a building or house. Step 660 involves determining a housewrap package configuration based on the set of housewrap specifications according to an optimization algorithm. In some cases, the housewrap package configuration can also be based on other factors, such as a set of delivery instructions, a logistics provider pricing schedule, and the like.

In some cases, a customer may wish to order housewrap based on building plan drawings or specifications. A housewrap order for a single house may include data that reflects or correlates with a variety of housewrap pieces having various dimensions, such as width, length, and the like, optimized or otherwise customized for the particular house. This data can correspond with the building plan drawings or specifications. For example, a housewrap order can contain instructions for a housewrap package to include multiple precut pieces to cover entire wall sections. Each piece can be a specific width and length. In some cases, the dimensions of the housewrap pieces can be determined by an optimization algorithm, based on the building plan drawings or specification, optionally in conjunction with other factors such as a set of delivery instructions, a logistics provider pricing schedule, and the like. For example, an algorithm can be used to determine the optimum piece sizes that economically fit into shipping boxes. An algorithm can also generate assembly or installation instructions based on the housewrap order. The precut pieces can be tagged or marked to identify their application locations, and the assembly or installation instructions can refer to various pieces in the housewrap package according to their tagging or marking identification.

Algorithms for optimizing housewrap packages based on building plan drawings or specifications may be included in or implemented by one or more modules of a host computer, a packaging computer, and/or a logistics computer. Methods and systems for determining the precut sizes of housewrap to be packaged can involve modules or means configured to read or input such plan drawings or specifications, and to determine practical precut piece sizes to fit the building. The precut sizes can be selected or determined so as to provide economical package and shipping configurations.

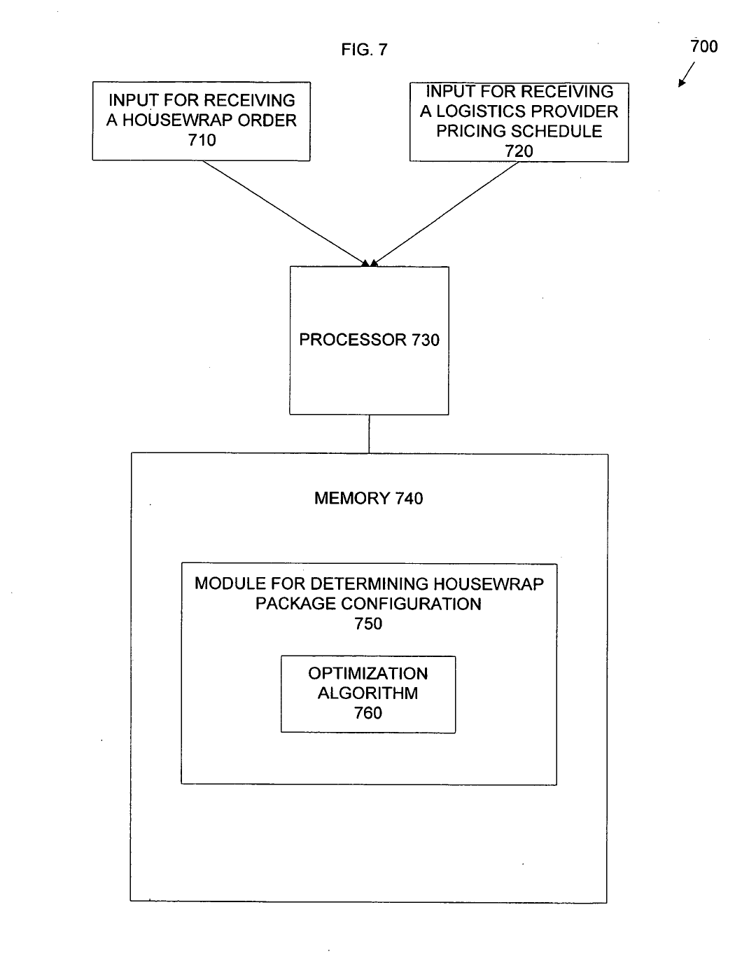

FIG. 7 schematically illustrates a simplified set of components and modules of a system 700 for carrying out a method according to one embodiment of the present invention. The modules may be software modules on a computer readable medium that is processed by processor, hardware modules, or a combination thereof. System 700 includes an input 710 for receiving a housewrap order, an input 720 for receiving a logistics provider pricing schedule, and a processor 730 coupled with both inputs. System 700 also includes a memory 740 coupled with processor 730. Memory 740 can be configured to store a plurality of code modules 750 for execution by processor 730. In one embodiment, the plurality of code modules 750 includes a module 760 for determining the housewrap package configuration based on the housewrap order and the logistics provider pricing schedule. Module 760 may also include an optimization algorithm 770.

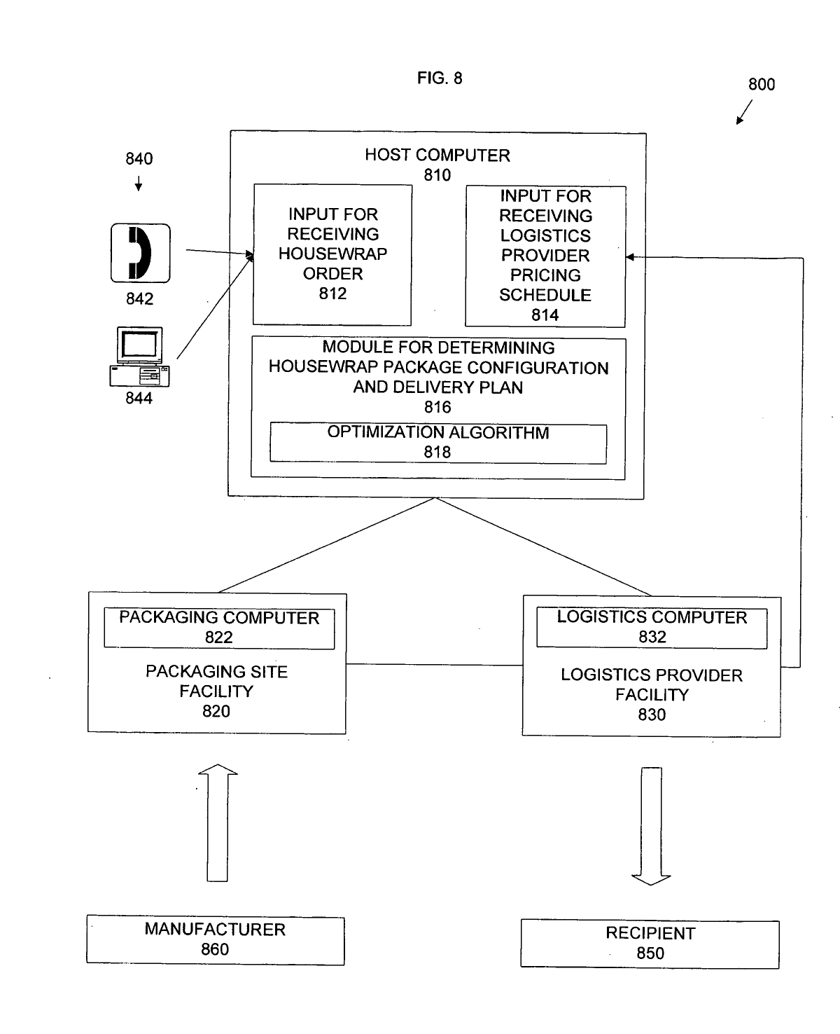

FIG. 8 depicts one embodiment of a system 800 for providing a housewrap package to a recipient. System 800 includes a host computer 810 having a first input 812 that receives a housewrap order, a second input 814 that receives a logistics provider pricing schedule. First input 812 can receive a housewrap order via any suitable communications means 840, including a telephonic means 842, a computer or network means 844, and the like. Second input 814 typically receives a logistics provider pricing schedule either directly or indirectly from a logistics provider facility 830. System 800 also includes a module 816 that determines a housewrap package configuration and a delivery plan based on the housewrap order and the logistics provider pricing schedule. A housewrap package configuration may include, for example, an indication of how many housewrap sheets having specified dimensions are included in one or more shippable containers. A delivery plan may include, for example, a delivery date, a delivery location, a delivery route, a delivery schedule, and the like, for a housewrap package or portion thereof. Module 816 can also include an optimization algorithm 818. System 800 further includes a packaging site facility 820 having a packaging computer 822 that receives the housewrap package configuration from host computer 810. Packaging site facility 820 is adapted to produce the housewrap package according to the housewrap package configuration. Packaging site facility 820 may include one or more buildings at one or more locations, and often includes transport means or networks for delivering materials or information to various locations within the facility or to offsite locations. In some cases, packaging site facility 820 produces housewrap master rolls on-site. In other cases, housewrap master rolls are delivered from a housewrap manufacturer site to packaging site facility 820. System 800 also includes a logistics provider facility 830 having a logistics computer 832 that receives the delivery plan from host computer 810. Logistics provider facility 830 is adapted to deliver the housewrap package to a recipient 850 according to the delivery plan. Logistics provider facility 830 may include one or more buildings at one or more locations, and often includes transport means or networks for delivering materials or information to various locations within the facility or to offsite locations. In some embodiments, logistics provider facility 830 may be a hub of a package delivery company, or may encompass portions of, or the entirety of, a package delivery company itself.

Housewrap sheets and packages may include any of a variety of housewrap brands, including Gorilla Wrap™, which is a translucent, non-perforated, nonwoven polymeric housewrap produced by Johns Manville's Engineered Products Group. Gorilla Wrap™, is tear resistant, and contains ultraviolet inhibitors. The housewrap reduces potential for bulk water penetration and allows trapped moisture to escape, thus reducing concerns about mold and mildew growth. In addition, it keeps wood sheathing dry, reducing the potential for rot and degradation within the wall cavity.

It will be appreciated that the systems and method described herein can be utilized for any of a variety of building materials including roofing underlayment and other drainage plane materials. Such materials are often water repellent or water resistant, are located behind the cladding of a house, and are designed to drain water that passes through the cladding, siding, roofing, or other material that covers a house.

Although certain system, device, and method embodiments have been disclosed herein, it will be apparent from the foregoing disclosure to those skilled in the art that variations, modifications, alternative constructions, and equivalents of such embodiments may be made without departing from the true spirit and scope of the invention. Therefore, the above description should not be taken as limiting the scope of the invention which is defined by the appended claims.

What is claimed is:

1. A method of providing a housewrap package to a recipient via a logistics provider, comprising:
receiving a housewrap order at a host computer, the housewrap order including a set of housewrap specifications and a set of delivery instructions;
transmitting the set of housewrap specifications from the host computer to a packaging computer of a packaging site;
processing a sheet of housewrap at the packaging site according to the set of housewrap specifications so as to produce a housewrap package;
transporting the housewrap package to the logistics provider hub;
transmitting the set of delivery instructions from the host computer to a logistics computer of a logistics provider, such that the logistics provider is instructed to deliver the housewrap package from the logistics provider hub to the recipient according to the set of delivery instructions.

2. The method as in claim 1, wherein the packaging site and the logistics provider are different business entities.

3. The method according to claim 1, wherein the set of housewrap specifications are customized for a specific building.

4. The method according to claim 1, wherein the housewrap order is received at the host computer via an internet or telephonic interface.

5. The method according to claim 1, wherein the set of housewrap specifications is transmitted from the host computer to the packaging computer via a printed, telephonic, or verbal interface.

6. The method as in claim 1, wherein the housewrap package is configured according to an optimization algorithm based on the housewrap order and a logistics provider pricing schedule.

7. The method as in claim 5, wherein the logistics provider pricing schedule comprises a set of preselected package sizes.

8. The method as in claim 1, wherein processing the sheet of housewrap comprises:
unwrapping a portion of the sheet of housewrap from a roll;
cutting a length of the unwrapped portion of the sheet of housewrap from the roll; and
packaging the length of housewrap in a container having a preselected package size according to a logistics provider pricing schedule.

9. The method as in claim 1, wherein the recipient comprises a member selected from the group consisting of a contractor, a homeowner, and a building materials supply store.

10. The method as in claim 1, wherein the set of housewrap specifications are selected by the recipient.

11. The method as in claim 1, wherein the set of housewrap specifications comprises a member selected from the group consisting of a length selection, a width selection, and a printing selection.

12. The method as in claim 1, wherein the set of delivery instructions include a shippable container size selected by the recipient.

13. The method as in claim 1, wherein the packaging site is located near a logistics provider hub.

14. A method as in claim 1, further comprising including a housewrap accessory in the housewrap package.

15. A method as in claim 1, further comprising including a housewrap accessory in an accessory package that is separate from the housewrap package, wherein the accessory package is configured to be shipped and delivered with the housewrap package.

16. A method of determining a housewrap package configuration, comprising:
receiving a housewrap order;
determining the housewrap package configuration based on the housewrap order and a logistics provider pricing schedule.

17. A method as in claim 16, wherein the housewrap order comprises a set of housewrap specifications and a set of delivery instructions.

18. The method as in claim 17, wherein the set of housewrap specifications comprises a length selection and a width selection and the set of delivery instructions comprises a shippable container size.

19. The method as in claim 16, wherein the housewrap package configuration is determined according to an optimization algorithm.

20. The method as in claim 16, wherein the logistics provider pricing schedule comprises a set of preselected package sizes.

21. A system for determining housewrap package configuration, comprising:
an input for receiving a housewrap order;
an input for receiving a logistics provider pricing schedule;
a processor coupled with each of the inputs; and
a memory coupled with the processor, the memory configured to store a plurality of code modules for execution by the processor, the plurality of code modules comprising:
a module for determining the housewrap package configuration based on the housewrap order and the logistics provider pricing schedule.

22. The system as in claim 21, wherein the module for determining the housewrap package configuration comprises an optimization algorithm.

23. A system as in claim 21, where the module is adapted to determine the housewrap package configuration based on a space use variable associated with a transport vehicle, a retail outlet, or a lumber yard.

24. A system for providing a housewrap package to a recipient, comprising:
a host computer having a first input that receives a housewrap order, a second input that receives a logistics provider pricing schedule, and a module that determines a housewrap package configuration and a delivery plan based on the housewrap order and the logistics provider pricing schedule;
a packaging site facility having a packaging computer that receives the housewrap package configuration from the host computer, the packaging site facility adapted to produce the housewrap package; and
a logistics provider facility having a logistics computer that receives the delivery plan from the host computer, the logistics provider facility adapted to deliver the housewrap package to the recipient according to the delivery plan.

25. The system as in claim 24, wherein the module for determining the housewrap package configuration and the delivery plan comprises an optimization algorithm.

26. The system as in claim 24, wherein the packaging site facility is adapted to include a housewrap accessory in the housewrap package.

27. The system as in claim 24, further comprising means for inputting a building plan drawing or specification, wherein the module is configured to determine a set of precut size housewrap pieces according to the building plan drawing or specification.

28. The system as in claim 27, wherein the module comprises an optimization algorithm that determines the set of precut size housewrap pieces according to an economical package and shipping configuration.
